(19) United States
(12) Patent Application Publication
(10) Pub. No.: US 2018/0138477 A1
(43) Pub. Date: May 17, 2018

(54) BATTERY SUPPORT WITH TOLERANCE EQUALIZATION ELEMENT

(71) Applicant: Benteler Automobiltechnik GmbH, Paderborn (DE)

(72) Inventors: Christian HANDNING, Langenberg (DE); Andreas HITZ, Erwitte (DE); Thomas OLFERMANN, Salzkotten (DE)

(21) Appl. No.: 15/800,622

(22) Filed: Nov. 1, 2017

(30) Foreign Application Priority Data
Nov. 7, 2016 (DE) 10 2016 121 254.7

(51) Int. Cl. H01M 2/10; B60L 11/18

(52) U.S. Cl. CPC H01M 2/1083; H01M 2220/20; B60L 11/1879; B60L 11/1877

(57) ABSTRACT

A battery support for an electric motor vehicle is disclosed. The battery support has a tray for receiving a plurality of batteries and a lid that closes the tray which has a base and a periphery that encircles the base. The battery support is produced as an integral thin-walled deep drawn component from a sheet metal blank, and reinforcement braces that extend from one wall side to the opposite wall side are disposed within the tray. A tolerance equalization element is disposed on the end side on a reinforcement brace.

### RELATED APPLICATIONS

The present application claims the priority of German Application Number 10 2016 121 254.7, filed Nov. 7, 2016, the disclosure of which is hereby incorporated by reference herein in its entirety.

### BACKGROUND

### 1. Field of the Invention

The disclosure is related to a battery support, and more specifically, to a battery support for an electric motor vehicle.

### 2. Description of the Related Art

As electric mobility increases, more and more electric motor vehicles are produced and registered to drive on roads. As opposed to motor vehicles having internal combustion engines, electric motor vehicles utilize electrical energy which is converted to propulsion energy by way of a drive apparatus.

In order for this electrical energy to be stored, batteries, also referred to as accumulators, which to some extent have a rather high proportion in terms of volume and a high deadweight in relation to the motor vehicle are provided. Most often, a multiplicity of such batteries is inserted into the underfloor region of a motor vehicle. In order for the batteries to be received and at the same time protected, battery supports, also referred to as battery trays, are known from the prior art. These battery supports most often are configured in a tray-shaped manner and have a lid for closing the battery support and thus the batteries that are received therein. This in most instances offers a protection of the batteries in relation to external weather influences and at the same time the possibility for vapors or liquids that emerge from the batteries to be trapped in the tray-type battery support and not to escape into the environment.

In order to meet crash and rigidity requirements set for the motor vehicle body, battery supports are increasingly configured in such a manner that the latter in the fitted state also carry out corresponding reinforcement of the motor vehicle body.

Reinforcement braces are disposed within the battery support in order for a battery support that is dimensioned in a corresponding size and most often extends from one motor-vehicle side to the opposite motor vehicle side to be reinforced. The reinforcement braces most often extend from one side to an opposite side of the battery support.

Since the battery support per se is disposed in the invisible underfloor region of the motor vehicle, there is significant cost pressure in terms of the production of the battery support. Since a plurality of individual parts have to be mutually coupled and joined, the individual parts in turn are subject to production tolerances in production. It is therefore an object to provide a battery support which can be produced in a simple, effective and cost-efficient manner and which at the same time meets crash and rigidity requirements.

### SUMMARY

According to one exemplary embodiment, a battery support for an electric motor vehicle is fitted in an underfloor region of the body. The battery support has a tray for receiving a plurality of batteries and optionally a lid that closes the tray. The tray per se has a base and an encircling periphery. According to the invention, the battery support is characterized in that reinforcement braces that extend from one wall side to the opposite wall side of the periphery are disposed within the tray. A tolerance equalization element is disposed on the end side on one, in particular on each, of the reinforcement braces.

According an exemplary embodiment, a production tolerance of the interior dimensions of the tray and/or of the length of the reinforcement braces can thus be equalized. Consequently, a battery support of which the floor of the tray is not configured in a bulged manner by way of excessively long or excessively short reinforcement braces be provided.

The tray can be configured as an integral thin-walled sheet metal component, in particular a deep drawn component. The tray can also be configured by a base and by an externally encircling frame that is coupled to the base. However, the tray can also be produced as a tray produced by folding or bending, respectively. Thus, a sheet metal blank is first cut out/punched. The sheet metal blank is then subsequently machined by bending or folding technology, respectively. To this end, the lateral walls are bent back in relation to a base and are coupled to each other at the corners that are created. Joining tabs are provided here in particular. The advantage of a tray produced by folding or bending, respectively, is that particularly tight bending radii, in particular smaller than or equal to (≤) 1.5 times the wall thickness are possible. In the case of a sheet metal blank having a thickness of 1 to 2 mm, bending radii between 1 and 3 mm are thus possible. An optimum in terms of the utilization of space in the interior is enabled. In particular, the batteries that are disposed in the tray of the battery support can be pushed as far as possible up to the periphery.

The reinforcement braces are preferably produced as profile components by extrusion or roll forming. Increased and cost intensive measures for cutting the reinforcement braces precisely to length will likewise be dispensed with by the tolerance equalization element according to the invention.

The tolerance equalization element is preferably disposed on an end side of each reinforcement brace. In a further preferred variant of design embodiment, in each case one tolerance equalization element can also be disposed on both end sides of one reinforcement brace. The reinforcement braces on the end side are preferably coupled to the internal wall of the periphery of the tray. Furthermore preferably, the reinforcement braces can also be coupled to the base of the tray by way of the longitudinal profile of the reinforcement braces.

The tray is preferably configured from a steel material or from a light metal material. Furthermore preferably, the reinforcement braces are likewise configured from a light metal or from a steel material. Particularly preferably, reinforcement braces are produced from an aluminum alloy of the 7.000 type. The reinforcement braces in particular have a yield strength Rp 0.2 of more than 300 MPa, in particular more than 450 MPA. The reinforcement brace, while incorporating the tolerance equalization element, is coupled to the internal wall of the periphery on at least one end side. The tolerance equalization element by way of adhesive bonding or welding can likewise be coupled to the periphery or to the reinforcement brace, respectively. The tolerance equalization element can also be coupled to at least the reinforcement brace by a form-fitting method, for example by riveting or else clinching.

To this end, the tolerance equalization element is fastened in particular to an internal side of the wall side and at least partially encompasses an end of the reinforcement brace in a lateral manner, in particular on both sides. To this end, the tolerance equalization element has two legs that are configured in a C-shape or a U-shape, respectively, which laterally encompass the reinforcement brace.

Furthermore, a gap is preferably configured between an end side of the reinforcement brace and the internal side of the wall side. The reinforcement brace is thus produced to an undersize, wherein the undersize is equalized by the tolerance equalization element. Excessively long oversized reinforcement braces that are outside the production tolerance are thus avoided according to the invention. Tolerances of the tray, or of the frame, respectively, can also be equalized by the undersized reinforcement braces.

The tolerance equalization element per se is preferably configured as an extruded component. Alternatively or additionally, the tolerance equalization element can also produced as a formed sheet metal component. In the case of an extruded component, tolerance equalization element in the cross-section is configured in particular so as to U-shaped or C-shaped or else T-shaped, having two webs. The extruded component is then furthermore preferably machined in terms of cutting technology and subsequently forming technology and optionally in a subtractive manner.

The tolerance equalization element in particular has receptacles for coupling to a battery. The receptacles can be bearing faces. However, the receptacles can also be assembly receptacles, having a welding or riveting nut, for example, or a threaded portion to which the batteries in the battery support are fastened.

Furthermore, the periphery preferably has outwardly directed moldings. The tolerance equalization element is inserted in the region of the molding. An internal shell face of the tray is thus configured so as to be substantially planar or flush, respectively, despite the tolerance equalization element being fastened to the rear side. Any potential thickening of the wall that is created on account thereof is compensated for by the outwardly directed molding.

### BRIEF DESCRIPTION OF THE DRAWINGS

For an understanding of embodiments of the disclosure, reference is now made to the following description taken in conjunction with the accompanying drawings, in which:

FIG. 1 is a perspective view of a prior art battery support;

FIG. 2 is a schematic view of a tolerance equalization element having a reinforcement brace;

FIGS. 3 to 6 are various detailed views of the interior space of the battery support having the tolerance equalization element inserted;

FIG. 7 is a perspective view of a tolerance equalization element produced by extrusion and forming;

FIG. 8 shows a battery support having the tolerance equalization element from FIG. 7;

FIG. 9 shows an alternative tolerance equalization element, produced by extrusion and forming;

FIG. 10 shows a tolerance equalization element, produced by sheet metal forming;

FIGS. 11 and 12 show a battery support having the tolerance equalization element illustrated in FIG. 10;

FIGS. 13 and 14 illustrate a reinforcement brace according to another exemplary embodiment, and the coupling of a tolerance equalization element to the periphery of a tray;

FIGS. 15a and b show a tray, as a component produced by folding; and,

FIGS. 16a and 16b show joining tabs that run at various orientations in the case of a tray according to FIG. 15.

In the figures, the same reference signs are used for identical or similar components, even if a repeated description is omitted for reasons of simplicity.

### DETAILED DESCRIPTION OF SOME EMBODIMENTS

Some embodiments will be now described with reference to the Figures.

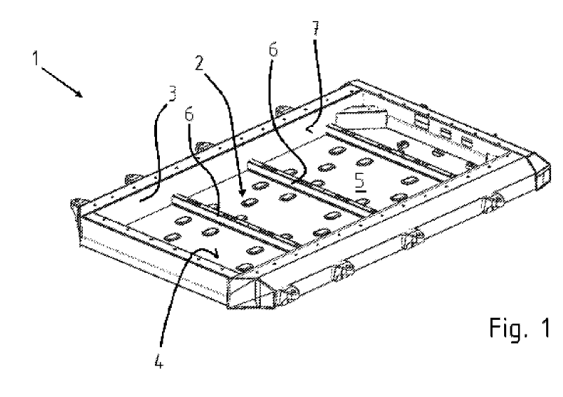

FIG. 1 shows a battery support 1 in a perspective view. The battery support 1 has a tray 2, wherein the tray 2 has an externally encircling periphery 3 and a base 4. Reinforcement braces 6 are disposed in an interior space 5 of the tray 2. The reinforcement braces 6 herein extend from a wall side 7 to an opposite wall side 7.

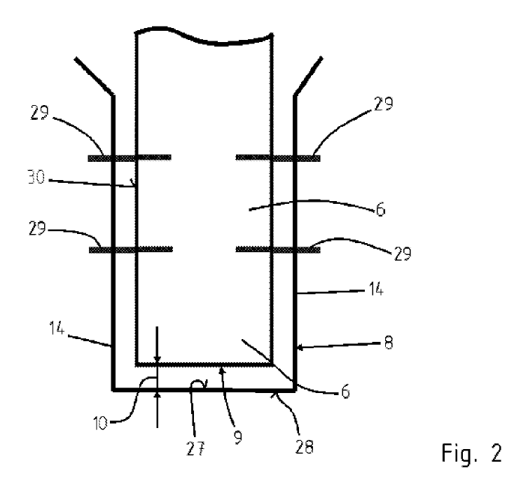

FIG. 2 shows a plan view of a tolerance equalization element 8 according to the invention. The latter by way of two legs 14 thereof encompasses the end of the reinforcement brace 6. A gap 10 is configured between an end side 9 of the reinforcement brace 6 and a rear-side web 27, such that different production tolerances of the reinforcement brace 6 and/or of the tray 2 can be equalized. A rear side 28 of the web 27 is coupled to the wall side (not illustrated) of the tray 2. Punctiform joint connections 29, for example by way of rivets or spot welds, can then be established between the legs 14 and a respective side 30 of the reinforcement brace 6.

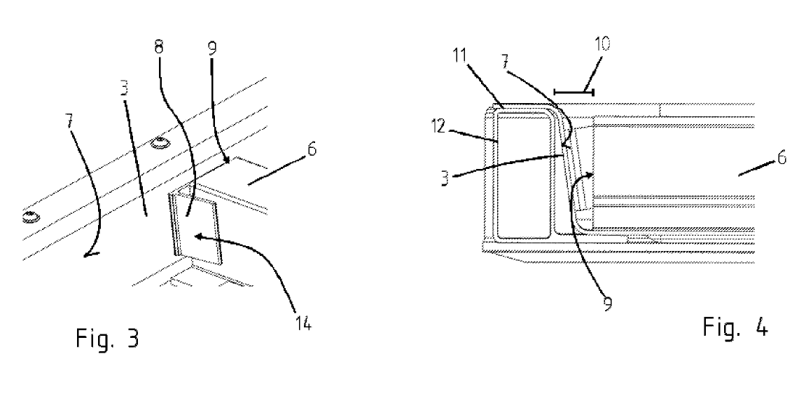

The tolerance equalization elements 8 are shown in a detailed illustration in FIG. 3. The tolerance equalization element 8 in the cross-section is configured so as to be substantially C-shaped. A rear side of the tolerance equalization element 8 is coupled to the wall side 7. An end side 9 of the reinforcement brace 6 does not lead up to the wall side 7. According to FIG. 4, a gap 10, or a spacing, respectively, thus remains between the end side 9 of the reinforcement brace 6 and the wall side 7 of the periphery 3 of the tray 2.

It can furthermore be seen in FIG. 4 that an externally projecting flange 11 of the tray 2 is formed, the flange bearing on an externally encircling frame 12. The frame 12 can also be configured from a hollow section, in particular from a multi-chamber hollow section.

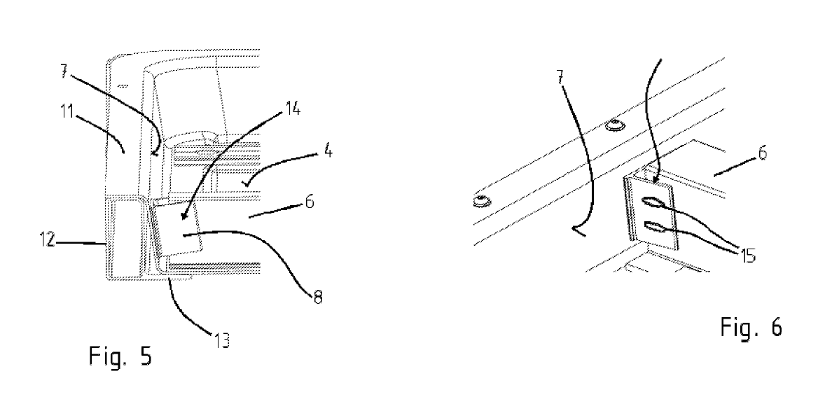

The frame 12 according to FIG. 5 visibly has also a web 13 that protrudes at the bottom. The web 13 herein bears below the reinforcement braces 6, such that the reinforcement braces 6 while incorporating the base 4 bear on the web 13.

The tolerance equalization element 8 per se has two legs 14 by way of which the tolerance equalization element 8 in each case laterally encompasses the reinforcement brace 6. According to FIG. 6, two plug welds 15 can be performed, for example, such that the reinforcement brace 6 is coupled to the tolerance equalization element 8.

According to one exemplary embodiment illustrated in FIG. 7, the tolerance equalization element 8 is produced as an extruded profile and in a lower region of the rear-side web 27 has subsequently been cut into and bent such that receptacles 16, presently in the form of receptacle sockets for coupling to a battery (not illustrated in more detail), are present. The receptacle 16, by way of a joint seam 17 produced for example by welding, is preferably coupled to one of the legs 14 at a bent edge such that a higher rigidity of the receptacle 16 is provided.

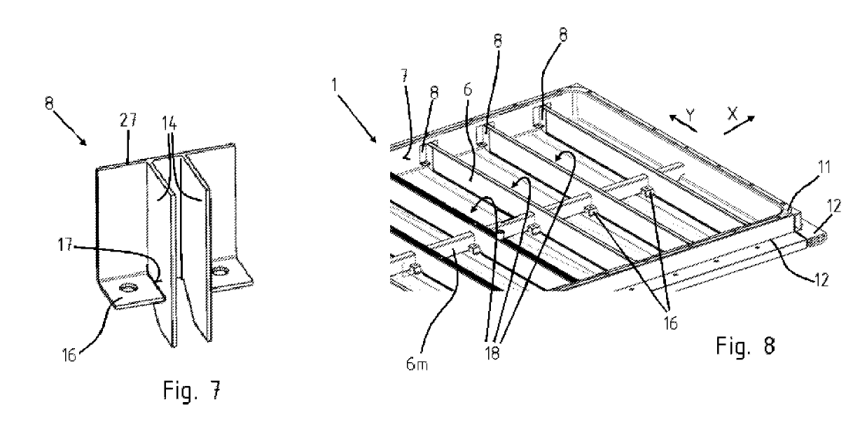

The tolerance equalization element 8 illustrated in FIG. 7 is installed in a battery support 1 in FIG. 8. The tolerance equalization element 8 is coupled to the reinforcement braces 6. The reinforcement braces 6 subdivide individual receptacle spaces 18 in which batteries (not illustrated in more detail) can be disposed. Receptacles 16, likewise for coupling to batteries (not illustrated in more detail), are also configured on the reinforcement braces 6 per se. The reinforcement braces 6 in the installed position here are oriented significantly in the motor vehicle transverse direction Y. As is likewise illustrated, a reinforcement brace 6m can also be disposed so as to run in the motor vehicle longitudinal direction X. The reinforcement braces 6 and 6m are thus mutually intersecting. Recesses or clearances can be present in the individual reinforcement braces 6, 6m such that the latter can be plug fitted into one another. An externally encircling frame 12 is likewise illustrated.

The flange 11 of the tray 2 bears on the frame 12. The frame 12 in the variant of design embodiment illustrated here is configured as a multi-chamber hollow section that in the cross-section is L-shaped. One leg of the L is configured so as to be oriented pointing away outward.

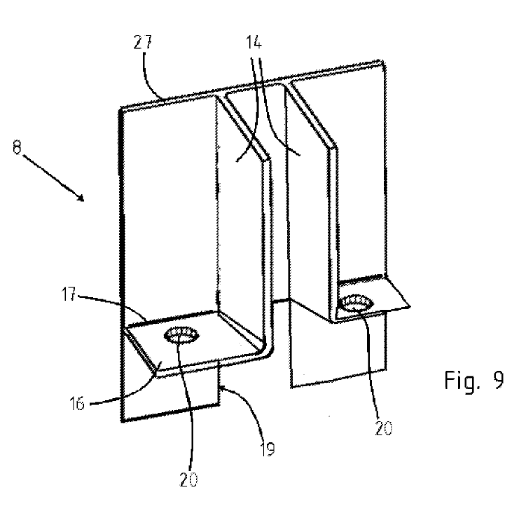

According to one exemplary embodiment illustrated in FIG. 9, the tolerance equalization element 8 is likewise produced as an extruded profile component, having two legs 14 and a rear-side web 27. The legs 14 on a cutting edge 19 are cut in and are laterally bent so as to form receptacles 16. A joint seam 17 is optionally provided also here, such that receptacles 16 are configured in a positionally fixed manner on the tolerance equalization element 8. The receptacles 16 can have assembly openings 20, for example for passing through a screw bolt or else for coupling to a nut or a rivet.

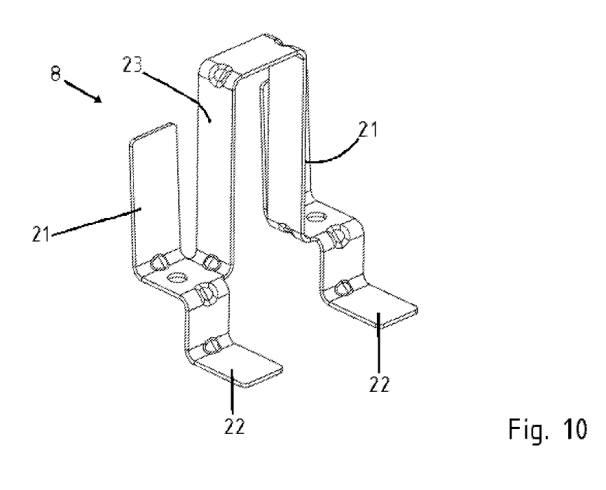

A further alternative variant of design embodiment of the tolerance equalization element 8 is illustrated in FIG. 10. The tolerance equalization element 8 here is configured as a formed sheet metal component and in particular from a bracket component. The tolerance equalization element 8 has at least one coupling portion 21, of which two are illustrated here, for coupling to the wall side (not illustrated in more detail) of the battery support 1. The coupling portion 21 is connected to a second coupling portion 22 in integral and materially integral manner. The second coupling portion 22 is suitable for securing to the base 4 of the tray 2. The tolerance equalization element 8 furthermore has a holding portion 23. The holding portion 23 is configured as a hanger body and encompasses laterally the reinforcement brace 6 and also engages across the reinforcement brace 6 on an upper side which is opposite the base 4. The holding portion 23 is thus configured as a bracket portion that engages across the reinforcement brace 6.

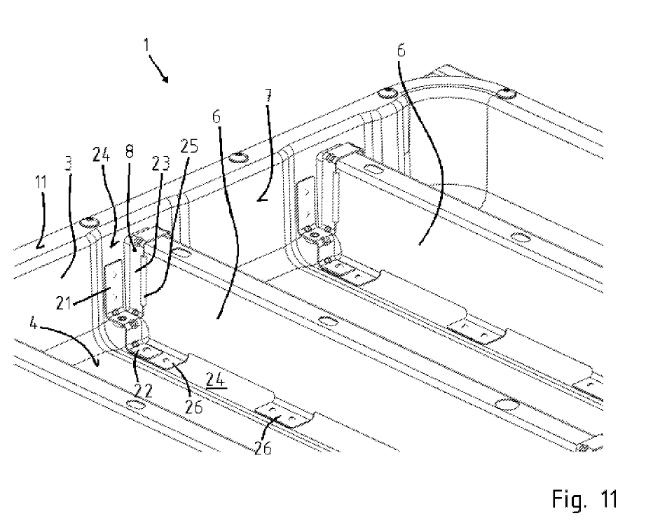

FIG. 11 shows the tolerance equalization element 8 in the installed position in a battery support 1 according to the invention. The reinforcement braces 6 are configured so as to extend from a wall side 7 to the opposite wall side 7. Outwardly directed moldings 24 are configured in the wall side 7 of the periphery 3. Outwardly directed moldings 24 are also configured on the base 4. The coupling portion 21 and the second coupling portion 22 can be in each case coupled to the wall side 7 and/or the base 4 by way of spot welds. The holding portion 23 is coupled to the reinforcement brace 6 by way of a joint seam 25. The reinforcement brace 6 per se can have flanges 26 by way of which the former is coupled to the base 4, for example also by way of a spot weld. The reinforcement brace 6 can thus be configured as a formed sheet metal component.

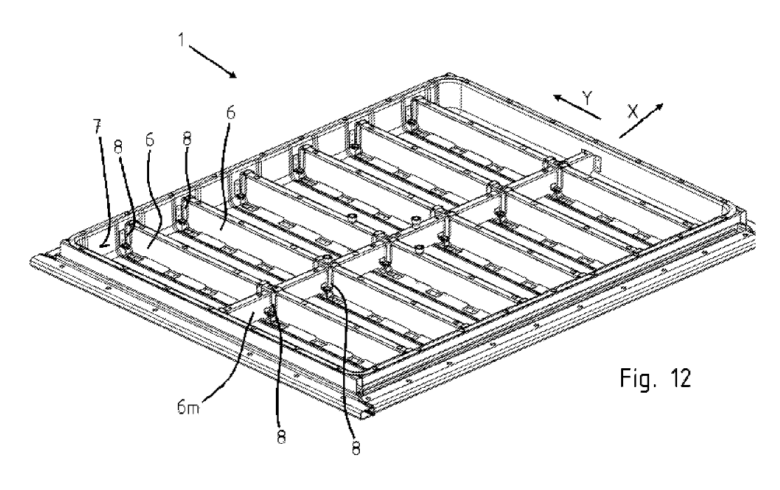

FIG. 12 shows the battery support 1 from FIG. 11 in an overall view. The tolerance equalization elements 8 are disposed not only on the respective wall side 7 but also on a central reinforcement brace 6m such that the individual reinforcement braces 6 which run in the motor vehicle transverse direction Y are gripped at each of the end sides thereof by one tolerance equalization element 8.

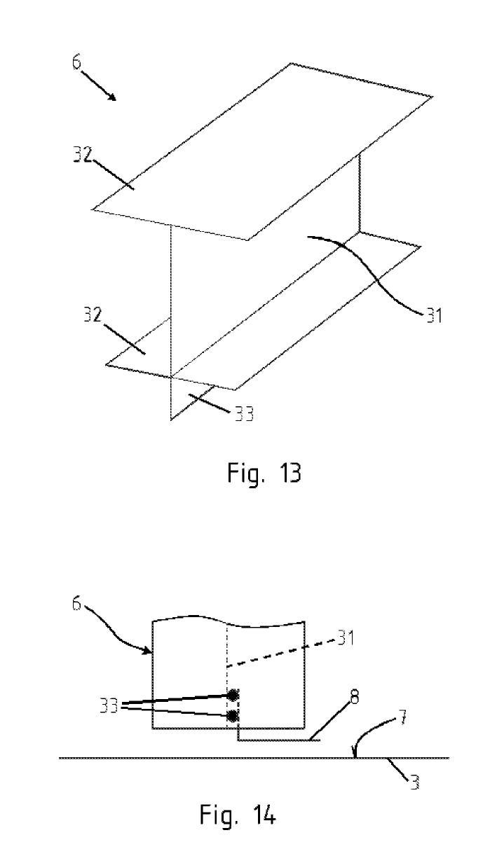

FIG. 13 shows an alternative variant of design embodiment of a reinforcement brace 6. The latter in the cross-section is configured so as to be double-T-shaped. A long double-T web 31 extends between the two mutually opposite T webs 32. A reinforcement web 33 that projects downward is additionally configured. It is illustrated according to FIG. 14 that the tolerance equalization element 8, here in the form of an L-shaped leg, is coupled to the wall side 7 of the periphery 3. A further part then bears on the long double-T web 31 and by way of joint connections 34, for example by way of connections 33, is for example spot welded to the double-T web 31. A particularly good lateral accessibility and an automatic, for example robotic, welding thus carried out is possible. An adequate connection between the reinforcement brace 6 and the encircling periphery 3 of the tray 2 is configured by the tolerance equalization element 8.

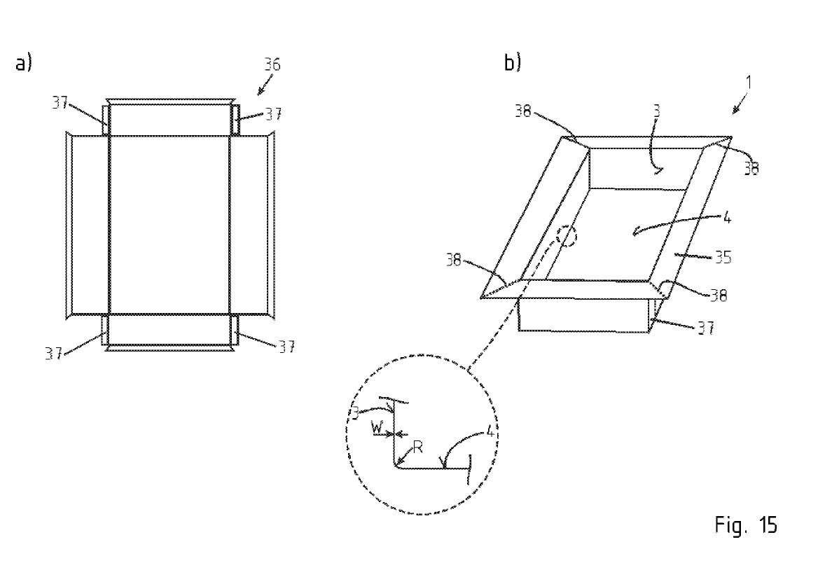

FIGS. 15a and b show a tray 2 according to the invention, as a component produced by folding. The tray 2 has a base 4 having an encircling periphery 3 and a flange 35 that projects from the periphery 3. The tray 2 is illustrated in FIG. 15b. However, first a blank 36 is machined in terms of cutting technology according to FIG. 15a, in order for the blank 36 to be then formed to the component illustrated in FIG. 15b. This forming is performed by bending or falling, respectively. To this end, in particular the cut-out blank 36 has joining tabs 37 which then are subsequently folded over and are joined to the periphery 3, for example by welding or adhesive bonding. The enlarged view of FIG. 15b shows the advantage according to the invention according to which a particularly tight bending radius R can be produced in a transition from the periphery 3 to the base 4. The bending radius R herein is smaller than or equal to (≤) 1.5 times the wall thickness W. The externally projecting flange 35 is coupled by way of an obliquely oriented joint seam 38 that runs outward, preferably at an angle of 45°.

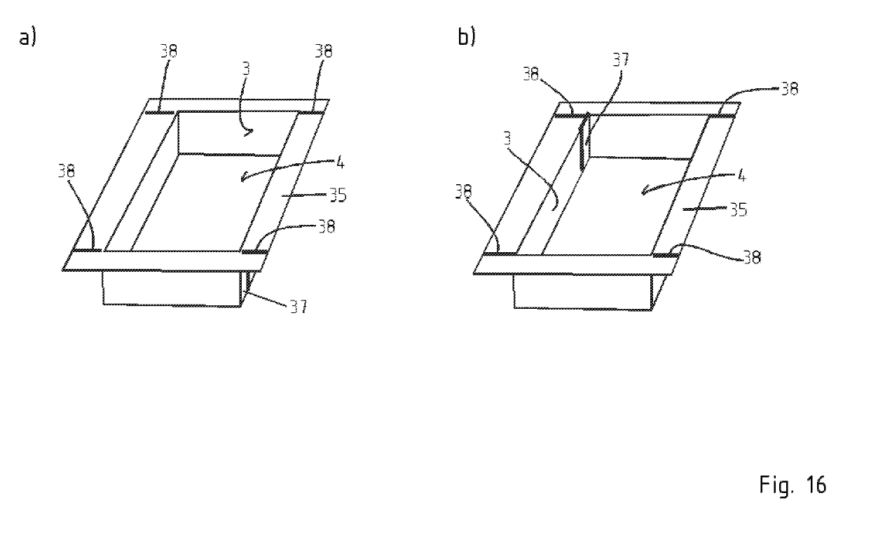

FIGS. 16a and b show alternative variants of embodiment. The orientation of the joint seam 38 for coupling the externally encircling flange 35 is aligned in a different manner In particular, the joint seam 38 runs straight in relation to the end wall at the head side. The joining tab 37 in the case of the variant of design embodiment according to FIG. 16a is coupled to the periphery 3 in an outboard manner; in the case of the variant of design embodiment according to FIG. 16b the joining tab 37 is coupled to the periphery 3 in an inboard manner.

The tolerance equalization elements according to the invention can then be disposed on the inside in all variants of embodiment according to FIGS. 15a, b and 16a, b.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A battery support for an electric motor vehicle, which is fitted in an underfloor region of an electric motor vehicle, comprising:
a tray for receiving a plurality of batteries a lid that closes the tray has and includes a base and a periphery that encircles the base, wherein at least one reinforcement brace extends from one wall side to an opposite wall side and are disposed within the tray, and wherein a tolerance equalization element is disposed on the end side on at least one reinforcement brace.

2. A battery support according to claim 1, wherein the at least one reinforcement brace is configured as an extruded profile, or in that the at least one reinforcement brace is configured as a formed sheet metal component having a yield strength Rp 0.2 of more than 300 MPa.

3. A battery support according to claim 2, wherein the tray is configured from a light metal alloy or a steel alloy, and/or in that the reinforcement braces are configured from a light metal alloy or a steel alloy, wherein the tray is produced as an integral thin-walled deep-drawn component from a sheet metal blank.

4. A battery support according to claim 3, wherein the tolerance equalization element is fastened to an internal side of the wall side of the periphery and at least partially encompasses an end of the at least one reinforcement brace and/or is coupled to the end of the at least one reinforcement brace.

5. A battery support according to claim 1, wherein a gap is configured between an end side of the at least one reinforcement brace and the internal side of the wall side.

6. A battery support according to claim 1, wherein the tolerance equalization element is configured so as to be C-shaped or U-shaped, respectively, in the cross-section, or is configured as an L-shaped tolerance equalization element.

7. A battery support according to claim 1, wherein the tolerance equalization element has receptacles (16) for fastening a battery, the tolerance equalization element having fastening elements in the form of threaded supports.

8. A battery support according to claim 1, wherein the tolerance equalization element is configured as an extruded component or as a cold formed part which optionally is machined in terms of forming technology and/or cutting technology and/or subtractive technology, or in that the tolerance equalization element is configured as a formed sheet metal component.

9. A battery support according to claim 1, wherein the tolerance equalization element is coupled to the internal side of the wall side and/or to the end of the at least one reinforcement brace in a form-fitting and/or materially integral and/or force-fitting manner.

10. A battery support according to claim 1, wherein the tolerance equalization element is additionally coupled to the base.

11. A battery support according to claim 1, wherein the at least one reinforcement brace in the cross-section is configured so as to be double-T-shaped, wherein the tolerance equalization element is coupled to the encircling periphery and to the long double-T web of the at least one reinforcement brace.

12. A battery support according to claim 1, wherein the at least one reinforcement brace is configured as a roll-formed component.

13. A battery support according to claim 1, wherein the at least one reinforcement brace is configured as an extruded profile.

14. A battery support according to claim 1, wherein the at least one reinforcement brace is configured as a formed sheet metal component having a yield strength Rp 0.2 of more than 450 MPa.
